(19) United States
(12) Patent Application Publication
(10) Pub. No.: US 2023/0345605 A1
(43) Pub. Date: Oct. 26, 2023

(54) Dynamically Controlled Scalable Lighting System

(71) Applicants: David BEAUDRY, North Hollywood, CA (US); Valeria BEAUDRY, North Hollywood, CA (US); Mitchell MASTRONI, North Hollywood, CA (US); Tim PIKE, North Hollywood, CA (US)

(72) Inventors: David BEAUDRY, North Hollywood, CA (US); Valeria BEAUDRY, North Hollywood, CA (US); Mitchell MASTRONI, North Hollywood, CA (US); Tim PIKE, North Hollywood, CA (US)

(21) Appl. No.: 18/024,765

(22) PCT Filed: Jun. 6, 2021
(86) PCT No.: PCT/US2021/036059

§ 371 Date: Mar. 5, 2023

Related U.S. Application Data
(60) Provisional application No. 63/035,752, filed on Jun. 6, 2020.

(51) Int. Cl. H05B 47/175

(52) U.S. Cl. CPC H05B 47/175

(57) ABSTRACT

A dynamically controlled scalable lighting system comprising a controller unit that receives network messages using known protocols from external show or lighting control systems and other external inputs and data streams. A base station connected to the controller unit using long-distance communication protocol network messages, where the base station also provides power, from at least one power source, to activate all light sprites. A link unit connected to the base station and light sprites to activate all light sprites attached to each link unit, wherein the light sprites are encapsulated in a custom molded enclosure that are sealed from the elements, and are individually controllable and dynamically respond to external inputs in real time.

### CROSS-REFERENCE TO RELATED APPLICATIONS

This Application claims the benefit under 35 U.S.C. § 119(e) of U.S. Provisional Pat. Application Ser. No. 63/035,752, filed on 2020-06-06, the contents of which are incorporated herein by reference in their entirety.

### FIELD OF THE INVENTION

The present invention is in the technical field of scalable lighting system and more particularly to a dynamically controlled scalable lighting system comprising generative animations and dynamic behaviors for controlling a large number of individual light sources with minimal requirements that can integrate into any environment using sensors and external communication protocols for interactive engagements.

### BACKGROUND

The problem with currently available lighting systems is that they cannot algorithmically simulate real life bio-luminescent insects or other lifeforms, such as LED-based fireflies, that both interact with people and have the capability to tie in to existing control systems, like showcontrol systems for larger show and story (programmed) moments.

For example, U.S. Pat. No. US7212932B 1 titled “Method For Emulating Visible Electromagnetic Spectrum Emissions Of Member Species Of Arthropoda Insecta Coleoptera Lampridae” provides a scientifically accurate visible electromagnetic spectrum light emissions of the bioluminescent abdominal ‘lantern’ of member species of the Lampyridae Family. Although useful for scientific research, it isn’t practical in a public setting.

Disney’s imitation of Lampyridae visible light emission flashing is utilized by a Santa Barbara, Calif. company, Creativations U.S. Pat. No. US7812547B2, titled “Systems And Methods For Ornamental Variable Intensity Lighting Displays,” utilizes a suspended horizontal wire from which vertical wires hang, each with a small electric fan in the middle of the wire and a light emitting diode (LED) at the end of the wire. The LED is covered with a black opaque substance eliminating light output from the device with the exception of a small area void of the opaque substance; thus creating a window that allows light emission.

Additionally United States Design Pat. No. USD580074S1 titled “Firefly Light Emitting Diode (LED)” only shows one potential shape of a light that could potentially be used in the present invention, but isn’t required, without any way of controlling the design.

Disadvantageously, these currently available systems lack key features. For example, current systems lack a dynamic connection to the physical environment. This includes motion sensors, camera and tracking systems, proximity sensors, sound input, and more. Additionally, there is no dynamic connection to individual movements and gestures of guests and performers, whether remotely sensed movements, or triggered by sensors embedded in props and costumes. Many current systems are not responsive to industry-standard show control messages (e.g., Art-Net, DMX, sACN, MIDI, network, etc.). The prior art is not generally ruggedized for long-term outdoor use in extreme weather conditions and direct sunlight. The current systems are not capable of representing behaviors found in nature. This included not only simulated blink patterns, but actively responding people and the physical environment. Also, the presently available systems do not incorporate sophisticated flocking algorithms (i.e. math that simulates how animals behave together as a group), such as, for example, ants, birds, bees, etc.

Moreover, these current systems are not capable of assigning behaviors to groups of simulated wildlife, such as, for example, fireflies (e.g., highly energetic and very engaging vs. shy and easily startled). Through sophisticated math and external sensors, groups of fireflies could automatically pick guests to interact and play with, sometimes following the guests around, sometimes leading them around the area in some wayfinding, or engaging in interactive gameplay. Nor do they have the ability to simulate movement of individual light sources. Nor the ability to tune the color of light source fixtures, down to the individual light source. Finally, none of the available systems have the capability of functioning on its own without the need for constant input from staff or operator.

Nothing currently exists in the market that could satisfy all these conditions.

Therefore, there is a need for a dynamically controlled scalable lighting system comprising generative animations and dynamic behaviors for controlling a large number of individual LEDs with minimal requirements that can integrate into any environment using sensors and external communication protocols for interactive engagements, that overcomes the limitations of the prior art.

### SUMMARY

A dynamically controlled scalable lighting system comprising one or more than one controller unit, where the controller unit receives network messages using known protocols from external show or lighting control systems. One or more than one external inputs and data streams are operably connected to the controller unit. One or more than one base station that is operably connected to the controller unit using long-distance communication protocol network messages where base station provides power to all the light sprites attached to each individual base station. One or more than one link unit operably connected to the one or more than one base station. One or more than one light sprite is operably connected to the link unit, where the light sprite is encapsulated in a custom molded enclosure that is sealed from the elements. The the light sprites are individually controlled, algorithmically, through adjustable control commands, or controllable and dynamically responsive to the external inputs in real time. At least one power source electrically connected to the controller unit and the base station that provides power to the light sprites and the entire system.

The controller unit converts incoming standard show/lighting control messages into network messages that are sent to each connected base station. The controller unit provides customizable system setup, real-time control, and advanced behavior customization of all light sprites on the same network. The one controller unit comprises one or more than one processor with instructions operable on the one or more than one processor for generating animations, generating dynamic behaviors, controlling a large number of individual light sprites with minimal requirements that can integrate into any environment using sensors and external communication protocols for interactive engagements, creating dynamic virtual fixtures based on customizable light sprite groupings, triggering preset animation behaviors, creating customized behaviors and modifiers for easy triggering, operating real time triggered queued scenes, mapping external inputs to light sprite control commands, creating fixtures based on light sprite groupings, allowing easy control from a central lighting control system, triggering preset animation behaviors, and creating customized behaviors and modifiers for easy triggering.

The controller unit functions independently, in communication with external control systems, or both independently and in communication with external control systems using a variety of communication protocols. The controller unit comprises instructions for controlling the base station, the chain, the link, and a cluster, where a cluster comprises a plurality of light sprites that operate as a logical group. The controller unit connects the light sprites to a larger show and lighting control systems, converting incoming standard lighting control messages into a streamlined proprietary format. The control unit comprises instructions for controlling light sprites with minimal requirements for interactive engagements, that can integrate into any environment using preset animations and real-time dynamic behavior simulations. The animations compre flocking behavior, natural characteristics, movement by living organisms, particle-like behavior including: fireworks, pixie dust, camera flashes, star fields, comets, moving lines, marquee lights, fire embers, and sparks.

The external input comprise existing show/lighting controllers. The control unit comprises executable instructions to receive the external inputs and display sophisticated behaviors for a user-definable number of light sprites to be triggered and modified, without overwhelming any connected system to create responsive spaces and engaging guest experiences by activating one or more light sprite in response to one or more external input. The external inputs comprise environmental sensors, tracking systems, identification systems, activated props, activated sets, motion sensors, cameras, depth sensors, LIDAR, RADAR, touch sensors, sound sensors, IR sensors, acoustic sensors, weather sensors, identification sensors, RFID, QR code, BLE beacons, marker and markerless camera tracking, and sensing technologies.

The base station comprises at least one processor and receives network messages from the controller unit and executes instructions executable on the processor to translate the received network messages to control commands and configuration information and apply the control command and configuration information to pre-existing programmatic behaviors as individual light sprite control data, that is passed to the correct chain, link, and sprite, wherein the generated animations and dynamic behaviors are pre-programmed, a real-time response to one or more than one external input, or both pre-programmed and a real-time response to one or more than one external input.

The base station receives network messages from the controller unit and translates the received network messages to control data, then sends the control messages along a chain to the link unit, and finally to a light sprite. The control data comprises color and brightness driver commands for the light sprites.

The link unit comprises: one or more than one power and data input port; one or more than one transceiver; power distribution for the light sprites attached to the link unit; light sprite drivers; and a wired, wireless or both wire and wireless connector for transmitting light sprite commands and optionally power. The link unit receives and decodes commands from the one or more than one base station and activates each individual light sprite to behave according to the commands.

Each light sprite is completely independent from the light sprite driver. The light sprite comprises an electrical and communication home run connection back to its corresponding link unit. Each light sprite is hot swappable without affecting the functionality of neighboring light sprites.

There is also provided a method for a dynamically controlled scalable lighting system comprising the steps of: first, loading a default state. Then, checking the current state. Next, accepting input from external control systems. Then, accepting input from external sensors and data streams. Next, determining if one or more than one light sprite value should be updated. Then, updating one or more than one light sprite parameters. Finally, transmitting a network message to one or more than one base station to control one or more than one individual light sprite.

### BRIEF DESCRIPTION OF THE DRAWINGS

These and other features, aspects and advantages of the present invention will become better understood with regard to the following description, appended claims, and accompanying figures where:

FIG. 1 is a system diagram of a dynamically controlled scalable lighting system comprising generative animations and dynamic behaviors for controlling a large number of individual light sprites with minimal requirements that can integrate into any environment using sensors and external communication protocols for interactive engagements, according to one embodiment of the present invention;

FIG. 2 is a schematic diagram of the system of FIG. 1;

FIG. 3 is a detailed schematic diagram of the system of FIG. 1;

FIG. 4 is a diagram of a link of the system of FIG. 3;

FIG. 5 is an example of a light sprite useful in the system of FIG. 3;

FIG. 6 is a block diagram of an embodiment of a base controller useful in the system of FIG. 3;

FIG. 7 is a block diagram of an embodiment of a link useful in the system of FIG. 3; and

FIG. 8 is a flowchart diagram of some instructions operable on the system of FIG. 1.

### DETAILED DESCRIPTION OF THE INVENTION

In the following description, certain terminology is used to describe certain features of one or more embodiments of the invention.

The term “light sprite” refers to a single controllable light source of any size or type with a customized shell.

The term “light sprites” refers to one or more than one light sprite.

The term “cluster” refers to a small subset or collection of individual light sprites that perform together as a functional unit to give a sense of motion and ease programming when translating individual light sprite behaviors to physical spaces. The movement is represented through sophisticated algorithms simulating flocking behavior and other natural characteristics and movement inspired by living organisms, where each light sprite has a programmatic awareness of itself and how it relates to the rest.

The term “chain” refers to an organizational unit of comprising one or more than one link unit and one or more than one sprite.

The term “network message” refers to UDP, TCP, OSC (OpenSoundControl), broadcast, and any other network protocol for sending control messages.

The present invention overcomes the limitations of the prior art by providing a dynamically controlled scalable lighting system comprising generative animations and dynamic behaviors for controlling a large number of individual light sprites with minimal requirements that can integrate into any environment using sensors and external communication protocols for interactive engagements.

The present invention was developed to answer these needs discussed above. The functionality of the system has evolved beyond just simple animal behaviors, like fireflies, to individually controllable light sprite, such as, for example LEDs, or RGB lasers with fiber optic wire, where the controllable light sprite can be of any size, shape, or configuration that dynamically respond to external input in real time, as well as a multitude of alternative external data streams that could influence the behavior of the system.

The system is a sophisticated lighting system that can be integrated into any indoor or outdoor environment to create generative animations and dynamic behaviors in either a pre-programmed manner or in response to one or more than one external input. Operating as a single lighting fixture or many, the system is scalable and capable of dynamically controlling a large number of individual light sprites with minimal requirements to the other connected systems. Examples of behaviors provided by the system include magic dust sparkles, fireflies, fire sparks, directional wayfinding, ocean bio-luminescence, fireworks, star and constellation fields, and much more.

One of the key innovative features of the system is its ability to be integrated with environmental sensors, tracking systems, identification systems, activated props and sets, and other sensing technologies to create responsive spaces and engaging guest experiences.

A system of individually controllable light sprites this large and expandable would typically consume a large number of channels in a show or lighting control system for advanced behaviors to be simulated. The system 100 software allows very sophisticated behaviors for a user-definable number of light sprites to be triggered and modified externally from their existing show/lighting controller, without overwhelming any connected system.

Light sprites can be placed anywhere and are not restricted to a regular pattern. No sheets, no strands, no LED strips or tape. Light sprites have the flexibility to be placed anywhere within the natural and built environment.

With the addition of input devices, real-time animation behavior modification is possible, including connection to the physical environment, people, groups, individuals, performers, and other data streams. Pre-programmed and interactive control are possible in the same system at the same time. Behaviors are not limited to pre-programmed patterns and can simulate organic movement (e.g., flocking, attraction/repulsion behaviors).

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a system or device disclosed in this disclosure will be determined by its intended use.

Methods and devices that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures can illustrate the architecture, functionality, and operation of possible implementations of systems, methods and computer programs according to various embodiments disclosed. In this regard, each block in the flowchart or block diagrams can represent a module, segment, or portion of code, that can comprise one or more executable instructions for implementing the specified logical function(s). It should also be noted that, in some alternative implementations, the functions noted in the blocks may occur out of the order noted in the figures. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function. Additionally, each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Moreover, a storage may represent one or more devices for storing data, including read-only memory (ROM), random access memory (RAM), magnetic disk storage mediums, optical storage mediums, flash memory devices and/or other non-transitory machine-readable mediums for storing information. The term “machine readable medium” includes, but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

Various embodiments provide a dynamically controlled scalable lighting system. In another embodiment, there is provided a method for using the system. The system and method will now be disclosed in detail.

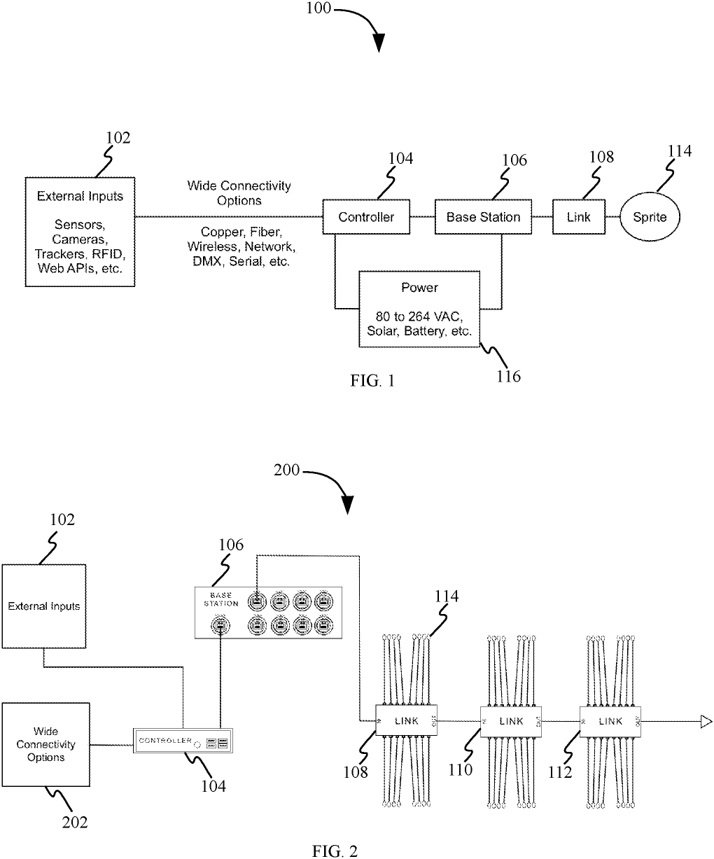

Referring now to FIG. 1, there is shown a system diagram 100 of a dynamically controlled scalable lighting system comprising generative animations and dynamic behaviors for controlling a large number of individual light sprites with minimal requirements that can integrate into any environment using sensors and external communication protocols for interactive engagements, according to one embodiment of the present invention. The basic system comprises one or more than one controller unit 104, one or more than one external input 102 is operably connected to the one or more than one controller unit 104, one or more than one base station 106 operably connected to the one or more than one controller unit 104, one or more than one link unit 108 operably connected to the one or more than one base station 106 and one or more than one light sprite 114 operably connected to the one or more than one link unit 108, and at least one power source 116 electrically connected to the one or more than one controller unit 104 and the one or more than one base station 106.

The system 100 extends the control of each individual light sprite beyond traditional means currently available for lighting control. The sections below discuss each component of the light sprite ecosystem.

### Controller Unit

The one or more than one controller unit is the CPU or processor “brain” at the center of the system. The one or more than one controller unit is the main connection of the components to a larger show and/or lighting control system, converting incoming standard lighting control messages into network messages that are sent to each connected base station. The one or more than one controller unit provides customizable system setup, real-time control, and advanced behavior customization of all light sprites on the same network. the one or more than one controller unit is also the first point of contact for interactive tie-ins to guest, performer actions, environmental inputs, and other external data streams.

The one or more than one controller unit functions independently, in communication with external control systems, or both independently and in communication with external control systems using a variety of methods selected from the group consisting of Art-Net, UDP, TCP, sACN or OSC. As will be understood by those with skill in the art, the external control system can comprise multiple communication protocols. The one or more than one controller unit communicates with the base station via network messages.

### Software Control

Each controller unit comprises executable instructions on a processor or software, that provides the following functionality:
Creating dynamic virtual fixtures based on customizable light sprite groupings;
Triggering preset animation behaviors;
Creating customized behaviors and modifiers for easy triggering;
Operating “in the moment”, and easily trigger queued scenes;
Mapping external input (e.g., sensors, data streams) to LED control.

The system 100 of lights as large and expandable as the present invention, can dominate a traditional lighting system’s IO channels and be tedious to control. The system 100 software comprises instructions that allows users to create groups of lights inside of the controller software, but create fixtures based on those user-defined groups that can be patched into architectural and show and lighting controllers and controlled externally using a minimal number of digital multiplex (DMX) channels. Logic in the software allows for individual lights to exist in multiple “fixtures” and appropriately respond when targeted without conflicts.

The system 100 is a configurable, real-world animated particle system at its core. Preset animations range from simple pre-defined sequences to more sophisticated algorithms simulating flocking behavior and other natural characteristics and movement inspired by living organisms. For fireflies, this not only includes approximating the lighting characteristics of the beetle, but clustering of light sprites to give the sense of movement by programmatic awareness of each light sprite and how it relates to neighboring light sprites. Other characteristics include moments of synchronization as observed with the fireflies of the Smokey Mountains in Tennessee.

The system 100 software settings can be tuned to simulate most any particle-like behavior, including: fireworks, pixie dust, camera flashes, star fields, comets, moving lines, marquee lights, fire embers, sparks, etc. As behaviors are generated real-time, a user defined animation can be exactly the same or unique each time it is triggered.

All of these elements are handled through the software control embedded in the light sprite controller and base stations.

### Base Station

The base station comprises at least one processor and receives control signals from the one or more than one controller unit and converts them into control data for each light sprite. While the one or more than one controller unit transmits configuration and timing information, the at least one processor in the base station receives the configuration information and applies the configuration data to pre-existing programmatic “behaviors” as individual light sprite control data, that is passed to the correct chain, link, and sprite. Each base station has the ability to function independently as well, generating configuration and timing information for each light sprite based on preset codes embedded within the base station’s one or more than one processor. Multiple base stations can be connected to the one or more than one controller unit. In this embodiment, the total number of light sprites a single base station can control is 1024. However, as will be understood by those with skill in the art, more than 1024 sprites can be controlled in other embodiments.

The base station communicated with each link via RS485 serial communication protocol. The RS485 protocol allows for long-distance communication between base station and the first link in each chain. Specific light sprite configuration and timing information is converted to the RS485 format and sent down a single twisted pair cable. The configuration and timing information is then converted back from an RS485 signal to a driver-specific format at each link. Specifics on light sprite communication and timing are governed by the selected light sprite driver. In the current embodiment this protocol is based on the readily available WS2811 LED driver chip. However, as will be understood by those with skill in the art, the specific light sprite configuration and timing information can be easily adjusted to accommodate alternative light sprite driver options.

### Chains

A chain is an organizational unit of comprising one or more than one link unit and one or more than one sprite. In this embodiment, each base station is capable of driving up to eight (8) chains. Individual chains comprise up to eight (8) daisy-chained link units, controlling up to 128 individual light sprites. Chains may be shorter than 8 Links long. However, as will be understood by those with skill in the art, more than chains, links, and light sprites can be controlled in other embodiments.

### Link Units

Link units comprise light sprite drivers and final power distribution for up to sixteen (16) attachable light sprites. The link units receive and decode commands from the base station and activates each individual light sprite to behave according to the commands. Link units are daisy chained from the base station, with up to eight (8) link units maximum in a single chain in its current embodiment. Preferably, link units interconnect using a Cat5e cable with RJ45 connectors, however other interconnections are possible, and this embodiment is not meant to be limiting. Each link unit comprises a waterproof RJ45 housing, making the interconnects installable in the field using T-568B wiring. Distance from the base station to the first link unit can be up to one hundred (100) feet, and the distance between link units can be up to twenty-five (25) feet. As will be understood by those with skill in the art, alternative lengths between base station and links and link to link are contemplated by the present invention. Link units can only be connected to base stations and are not independently network controllable. The RJ45 cable carries power and communication. Data communication uses the RS485 serial protocol for transmission of light sprite configuration and timing data. Within the link the configuration and timing information is then converted back from an RS485 signal to a driver-specific format at each link. Specifics on light sprite communication and timing are governed by the selected light sprite driver. In the current embodiment this protocol is based on the readily available WS2811 LED driver chip. However, as will be understood by those with skill in the art, the specific light sprite configuration and timing information can be easily adjusted to accommodate alternative light sprite driver options. In the present embodiment, each link contains sixteen (16) independently controllable light sprite driver chips connected in series.

### Light Sprite

At the end of the system 100 is one or more than one light sprite 114. In this embodiment, the standard light sprite comprises an RGB laser fiber end or single RGB LED. This can be encapsulated in a custom molded enclosure. For example, the enclosure is can be an elongated, stylized cone, meant to draw similarity to that of a firefly’s body. However, the light sprite is customizable to better serve different use cases by using other LED or light source options, sizes, and enclosures, such as, for example 5 mm RGB LEDs, 3 mm RGB LEDs, surface mount LEDs, small round enclosures, etc. The one or more than one light sprite 114 in each light sprite enclosure is sealed from the elements and connected to the light sprite link unit 106 via a custom cable designed for both its small outer diameter and ability to withstand weather and direct sunlight, or wirelessly without any degradation in performance. Unlike typical LED strands, each light sprite 114 comprises an electrical and communication home run either wired or wireless back to its corresponding link unit 106. Each of the one or more than one light sprite 114 is completely independent from the light sprite driver 708. The standard length of the home run cable is forty-eight (48) inches, but the lengths can also be customized for different use cases. The light sprite 114 arrangement gives the user the most flexibility in placement of light sprites 114 within foliage and other landscape or architectural features, and is a unique design to light sprites 114. Each light sprite 114 is hot swappable without affecting the functionality of the neighboring light sprites 114, allowing for easy repair and replacement. Light sprite cabling 504 can also be run through protective tubing, such as, for example, stainless steel tubing, to provide extra protection against landscape maintenance, animals, and other potentially destructive agents. And since the link units 106 comprise the light sprite drivers 708, losing the light sprite 114 through burnout, or even a break the cabling 504 from the link unit 106 to the light sprite, 114 will have no impact on the other light sprites 114 in the chain 316-332.

As can be appreciated by those with skill in the art with reference to this document, many different connections can be used for the external controls, such as, for example, copper, fiber, wireless, and mechanical contact closures. Different protocols can be used to communicate with the one or more than one controller unit, base station and link unit including: TCP, UDP, Art-Net, sACN, OpenSoundControl (OSC), and various Serial protocols (e.g., DMX, MIDI). Various sensor can be used as external inputs into the system 100 such as, for example, motion sensors, cameras, depth sensors, LIDAR, RADAR, touch sensor, sound, IR sensors, acoustic sensors, weather sensors, environmental sensor (such as thermal, moisture, light, etc.). Additionally, identification sensors, such as RFID, QR, BLE beacons, marker and markerless camera tracking can be used as input. Inputs can also be web-based APIs to provide traffic, weather, and social media/hashtag data. Power for the system 100 comprise battery, solar, mains voltage, and Power over Ethernet (PoE).

The invention contemplates many different applications for the invention, a nonexhaustive list is provided herein:
Fairy dust/magic dust sparkles/particles
Star fields and constellations
Guest/pathway/architectural/landscape wayfinding
Interactive or decorative pathway lighting
Interactive or decorative signage
Embedded in light fixtures (e.g., chandeliers)
Fireflies
Fantastical light-up creatures that respond to guest interactions
Fire effects/sparks
Ocean bioluminescence
Fireworks effects
Arcade cabinets
Family Entertainment Centers
Bowling alleys (e.g., track and light up as ball rolls down lane)
Mini-golf (e.g., track and light up courses based on location of golf ball)
Interactive holiday lighting (including Christmas, Halloween, New Years, 4th of July, etc.)
Architectural/hallway lighting
Stadium/Arena/Bowl celebrations/performances
Theatrical lighting
Exhibit effects
Restaurant/Retail Ambiance
Escape Room Puzzles/Ambiance
Warehouse wayfinding/asset location
Safety vests, where the vest could blink/light up as cars approach, or the vest could indicate function/role (e.g., aircraft carrier deck)
Respond to “where are you” messages (e.g., construction) for safety protocols, etc.
Social distancing (e.g., wearables, such as wristbands and necklaces, that light up when you are too close (with help of external tracking or ID system)

Referring now to FIG. 2, there is shown a schematic diagram 200 of the dynamically controlled scalable lighting system 100. The system 100 consists of four hardware components: one or more than one controller unit 104, one or more than one base station 106, one or more than one link unit 108-112, and one or more than one light sprite 114. The one or more than one controller 104 comprises programming instructions for controlling the one or more than one base station 106, chains 316-332, one or more than one link units 108-112, and clusters, where a cluster comprises four (4) light sprites in a custom enclosure that operate as a logical group. The schematic diagram 200 provides a general overview of how the components work together.

The one or more than one controller unit 104 is the processing “brain” at the center of the system 100. the one or more than one controller unit 104 serves as the main connection to a larger show and lighting control system (not shown), converting incoming standard lighting control messages into a more streamlined proprietary format comprising parameter control messages for state changes for one or more than one light sprite vs. color and intensity values for each individual light sprite at 44 Hz (standard DMX refresh rate). The one or more than one controller unit 104 provides customizable system setup, real-time control, and advanced behavior customization of the one or more than one light sprite 114 on the same network 202. The controller is also the first point of contact for interactive tie-ins to guest or performer actions, as well as environmental feedback shown as external inputs 102.

The one or more than one controller unit 104 receives network messages using known protocols, like UDP, TCP, OSC, Art-Net, sACN from external show or lighting control systems 102 and communicates with one or more than one base station 106 via network messages. Each of the one or more than one controller unit 104 comprises instructions executable on the processor for:
a) creating fixtures based on light sprite groupings, allowing easy control from a central lighting control system;
b) triggering preset animation behaviors; and
c) creating customized behaviors and modifiers for easy triggering.

One or more than one base station 106 receives network messages from the one or more than one controller unit 104 and translates the incoming messages to control data, that comprise color and brightness. These control messages are relayed along a chain 316-332 to a link 106 unit, and finally to the light sprite 114. The one or more than one base station 106 also provides power to the one or more than one light sprite 114 attached to their respective base station 106. In the current embodiment, each base station 106 can control up to one thousand twenty-four (1024) individual light sprites 114. However, as will be understood by those with skill in the art, more than 1024 light sprites 114 can be controlled. The distribution of light sprites 114 is via link unit 108-112 connected to each other in the chains 316-332.

Each base station 106 can power up to eight chains 316-332, each chain 316-332 comprises up to eight (8) link unit 108-112 units and one hundred twenty eight (128) light sprites 114. The one or more than one base station 106 is powered locally using standard AC power connection (80 VAC to 264 VAC). The AC power is converted to 48V DC power internally and distributed to each link unit 108-112 unit. In a preferred embodiment, the data connection comes from a network switch to the one or more than one base station 106 over a standard Cat5e network cable. In a preferred embodiment, each base station 106 comprises a standard RJ45 connectors, using T-568B wiring, and has its own waterproof RJ45 housing, making interconnects installable in the field and weather resistant. Data and power from the base station 106 to the link unit 108-112 unit is also done over a Cat5e cable. However, the one or more than one link 106 unit can only be connected to the base station 106 and are not independently controllable over the network 308.

Link units 108-112 comprise light sprite drivers 708 and power distribution 706 for up to sixteen (16) attached light sprites 114. Link units 108-112 are daisy chained, with up to eight (8) link units 108-112 in a single chain 316-332, to receive control messages from the one or more than one base station 106. Interconnectivity between link units is performed over a Cat5e cable with RJ45 connectors. Each link unit comprises its own waterproof RJ45 housing, making the interconnects installable in the field, using T-568B wiring. In this current embodiment, the distance from the base station to the first link unit can be up to one hundred (100) feet, and the distance between link units can be up to twentyfive (25) feet. As will be understood by those with skill in the art with reference to this disclosure, the distances are for example only and not meant to be limiting as future technological changes will naturally increase all the ranges cited herein.

At the end of the chain 316-332 is a light sprite 114. The standard light sprite 114 fixture is a 5 mm RGB LED in a custom molded enclosure. The standard enclosure is an elongated, stylized cone. As will be understood by those with skill in the art with reference to this disclosure, other LED options, light sources, sizes, and enclosures are possible for the light sprite 114, such as, for example a 3 mm RGB LEDs, surface mount LEDs, small round enclosures, etc. The one or more than one light sprite 114 is sealed from the elements, and connected to the link unit 108-112 wirelessly, wired, or both wired and wirelessly. If the connection is wired, a custom cable designed for both its small outer diameter and designed to withstand weather and direct sunlight is used.

Unlike typical light strands, each light sprite 114 comprises a home run communication to its corresponding link unit 108-112. In a preferred embodiment, a forty-eight (48) inch length of home run cable connects the light sprite 114 to the link unit 108-112, but the length of the home run cable is also customizable. This arrangement provides the user with the most flexibility in placement of the light sprite 114 within foliage and other landscape or architectural features, and is a unique aspect of the system 100. Further, each light sprite 114 is hot swappable, allowing for easy repair and replacement. If wiring is used for the home run cable, it can be run through protective tubing (e.g., stainless-steel tubing) to provide extra protection against landscape maintenance, animals, and other potentially destructive agents. Because the one or more than one light sprite driver 708 is contained with the one or more than one link unit 108-112 instead of the LEDs, as is typical in the prior art, losing a light sprite 114 because of burnout, or even a break the cabling from the link unit 108-112 to the light sprite 114, will have no impact on the other light sprites in the chain 316-332.

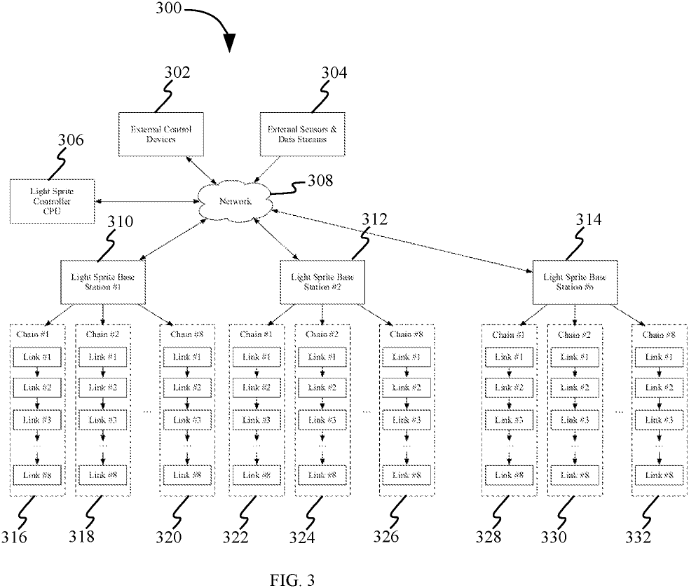

Referring now to FIG. 3, there is shown a detailed schematic diagram 300 of the system 100. As can be seen, external control devices 302, external sensors and data streams 304, are communicatively coupled via a network 308, the one or more than one light sprite controller CPU 306. The light sprit controller 306 takes the external inputs 302 and 304 and send commands to one or more than one light sprite base station 310- 312 and 314. The one or more than one base station 310-314 send the commands to one or more chains 316-332 comprising one or more than one link unit 108-112.

External control devices 302 include lighting consoles, media servers, and other show control devices. Messages to/from the external control devices 302 are transmitted and received via established network protocols (e.g., UDP, TCP, OpenSoundControl, sACN, multicast, broadcast) or serial protocols (e.g., DMX, MIDI). Output messages are usually control messages directed at the one or more than one controller CPU 306. Input messages are status messages reflecting the current state and health of the system. Connection to the Network can be via copper, fiber, wireless, or any other means capable of transmitting network or serial data. External control devices are optional inputs to the light sprite system.

External sensors and data streams 304, provide real-time dynamic input into the system 100. These include:
Remote sensing (e.g., location, motion, proximity, presence detection, etc.)
Sound (e.g., volume, pitch, timbre, musical structure, etc.)
Physical input (e.g., touch, press, pressure, orientation, vibration, motion/IMU sensors, etc.)
Environmental (e.g., thermal/heat, moisture/precipitation, light levels)
Identification (e.g., RFID, QR code, BLE Beacons, etc.)
Web API’s (e.g., traffic, weather, social media activity, etc.)

The destination for the external sensors and data streams 304 are the one or more than one controller unit CPU 306, via standard network 308 or serial protocols. The one or more than one controller unit CPU 306 uses the data to determine the state (e.g., color and intensity) of each light sprite 114. Optionally, external sensors and data streams 304 are input to the system 100.

The controller unit CPU 306 is the “brain” at the center of the system 100. The light sprites controller CPU 306 serves as the main connection to a larger show and lighting control system, converting incoming standard lighting control messages into a more streamlined format. The controller unit CPU 306 provides customizable system setup, real-time control, and advanced behavior customization of all light sprites 114 on the same network 308. It is also the first point of contact for interactive tie-ins to guest or performer actions, as well as environmental feedback. The light sprites controller CPU 306 can function both independently and in communication with external show or lighting control systems through a variety of protocols (e.g., Art-Net, UDP, TCP, OSC, sACN, MIDI). The light sprites controller CPU 306 communicates with the light sprite base stations 310-314 via network 308 messages.

The one or more than one base station 310-314 receives network control signals from the light sprites controller CPU 306 and interprets them into light sprite control data. While the light sprites controller 306 sends configuration and timing information, the processor on the one or more than one base station 310-314 does the heavy lifting of receiving the configuration information, applying it to pre-existing programmatic “behaviors”, and passing along one or more than one light sprite 114. Light sprite control data is sent to the correct chain 316-332, link 108, and the one or more than one sprite 114. In this embodiment, the total number of light sprites 114 that a single base station 106 can control is 1024. However, as will be understood by those with skill in the art with reference to this disclosure, other configurations can increase or decrease the number of light sprites 114 that can be controlled.

The one or more than one link unit 108-112 comprise light sprite drivers 708 and the final power distribution 710 for up to 16 attachable light sprites 114. The one or more than one link unit 108-112 receive and interpret messages from the one or more than one base station 106 and activate individual light sprites to behave according to instructions. The one or more than one link unit 108-112 are daisy chained from the one or more than one base station 108, with up to eight links 108-112 possible in a single chain, according to this embodiment that is not meant to be limiting in scope. The one or more than one link unit 108-112 are interconnected with a Cat5e cable having an RJ45 connector. Each of the one or more than one link 108-112 comprises a waterproof housing, making the interconnects installable in the field (using T-568B wiring). Distance from the Base Station to the first Link can be up to 100 feet, and the distance between Links can be up to 25 feet. Links can only be connected to Base Stations and are not independently network controllable.

Chains 316-332 are an organizational unit of one or more than one link unit 108-112 and one or more than one chain 316-332 of light sprites 114. In this embodiment, each base station 106 can drive up to 8 chains 316-332. Individual chains 316-332 consist of up to 8 daisy-chained links 18-112, controlling up to 128 individual light sprites 114. Chains 316-332 may be shorter or longer than the eight links 108-112 of this embodiment.

At the end of each chain 316-332 is a light sprite 114. In this embodiment, the standard light sprite 114 comprises a light source that is a 5 mm RGB LED, and a custom molded enclosure 506. The custom molded enclosure 506 is an elongated, stylized cone. Note that the one or more than one light sprite 114 can be customized to better serve different use cases by using other lighting options, such as, for example, more LEDs, sizes, and other custom enclosures (e.g., 3 mm RGB LEDs, surface mount LEDs, RGB laser with fiber optics cable, etc.). The one or more than one light sprite 114 is sealed from the elements, and is communicatively coupled to one or more than one link unit 108-112.

Unlike typical prior art LED strands, each chain 316-332 comprises a home run 504 back to its corresponding link unit 108-112. This arrangement gives the user the most flexibility in placement of the one or more than one light sprite 114 within foliage and other landscape or architectural features, and is a unique design to the system 100.

Each light sprite 114 is hot swappable, allowing for easy repair and replacement. If used, cabling can also be run through protective tubing (e.g., stainless steel tubing) to provide extra protection against accidental damage from landscape maintenance, animals, and other potentially destructive agents. Because the one or more than one light sprite driver 708 is contained with the one or more than one link 108-112, instead of coincident with the one or more than one light sprite 114, losing one of the light sprites 114 through burnout, or even a break the cabling from the one or more than one link unit 108-112 to the one or more than one light sprite 114, will have no impact on the other light sprites in the chain 316-332.

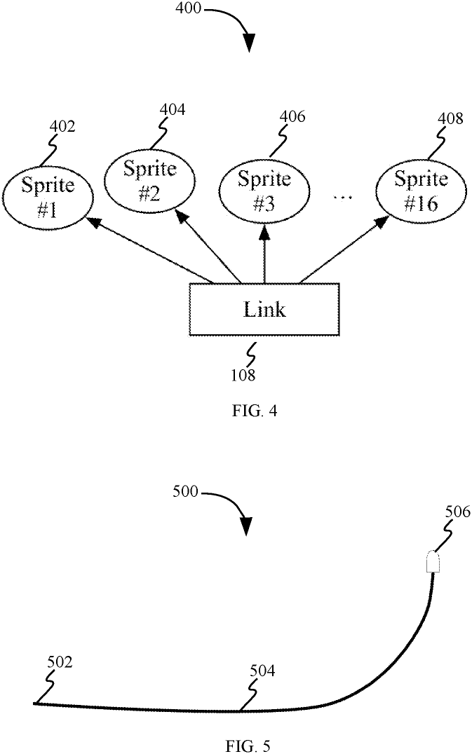

Referring now to FIG. 4, there is shown a diagram 400 of a link of the system 100. The link unit 108 comprises one or more than one home run 504 communicatively coupled to each light sprite 402, 404, 406 and 408.

Referring now to FIG. 5, there is shown an example of a light sprite 500 useful in the system 100. As can be seen the light sprite 500 comprises a multi-pin link unit connector 502, a cable 504 used to conduct power and data commands to the light sprite 114 light source in a customized enclosure 506. Communications by the one or more than one home run 504 can be wired, wireless or both wired and wireless depending on the use. In this embodiment, the light source and customized enclosure 506 is an RGB LED in a customized translucent white material shell for protection and diffusion of the emitted light and the one or more than one home run 504 is a wire. The multi-pin link unit connector 502 attaches to a single link unit 106.

Optionally, the light source and customized enclosure 506 comprises an independent power source and wireless communication home run coupled to the one or more than one link unit 106, eliminating the power and data cable 504 home run, and the multi-pin link unit connector 502.

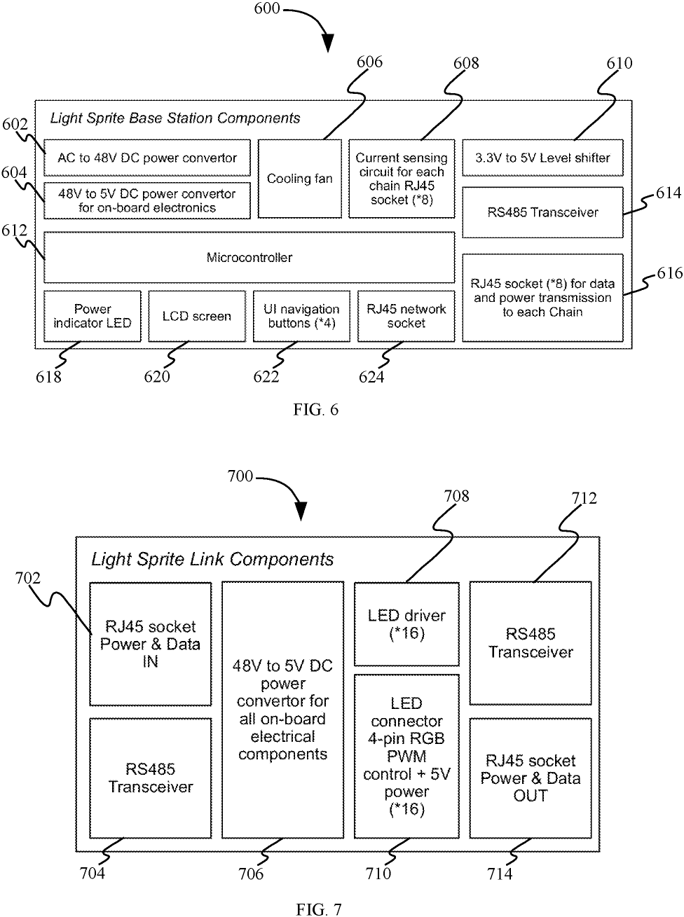

Referring now to FIG. 6, there is shown a block diagram 600 of an embodiment of a base controller useful in the system of FIG. 3. The light sprite base station receives control messages from the controller CPU via the RJ45 network socket. Messages are UDP packets containing RGB (red, green, blue) or HSV (hue, saturation, value/brightness) for each individual light sprite 114, or messages setting specific defined control parameters (e.g., overall RGB/HSV color values, min/max fade-in time, min/max HIGH hold times, etc.). The messages are received by the microcontroller 612 and translated into executable actions. Actions can be return network messages reporting status of the base station 106, or control messages for link units 106 determining the color and brightness of each individual light sprite 114.

The primary function of the microcontroller 612 is to control the color and brightness of each individual light sprite 114. Light sprite 114 control signals are distributed over 8 IO pins on the microcontroller 612. The signals generated have timing characteristics that can be interpreted by the drivers 708 found in each link unit 106 to control the three color channels of an RGB LED.

Before the control signals are passed along each chain 316-332, the signals are converted to an RS485 electrical signal. Although the input to the RS485 transceiver is not a traditional serial communication protocol, conversion to RS485 ensures signal integrity of the driver 708 signal over long distances. The signal is converted back to the original driver signal at each link unit 106, and converted back to RS485 after passing through all the driver 708 within the link unit 106 to pass along the remaining data to other link further down the Chain.

The RJ45 socket carries the RS485 signal over one of the twisted pairs in a Cat5e cable. The remaining Cat5e conductors carry 48V DC power and ground.

Referring now to FIG. 7, there is shown a block diagram 700 of an embodiment of a link useful in the system 100. The role of the light sprite link unit 106 is to receive the LED driver messages from the base station 106, convert the signal from RS485 to its original driver-specific signal, and distribute the signal to each driver chip 708. The driver chip 708 converts the incoming signal to PWM (pulse wave modulation) signals, which in turn determines the brightness and color for each light sprite 114. The drivers 708 are daisy chained together within the circuit board, slightly altering the signal after passing through each driver chip 708. After the signal passes through the last driver chip 708, it is converted back to an RS485 electrical signal and passed out the RJ45 socket via one of the twisted pairs in the Cat5e cable. to the next link unit 106 in the chain 316-332. A 48V DC power and ground is also passed along the same cable.

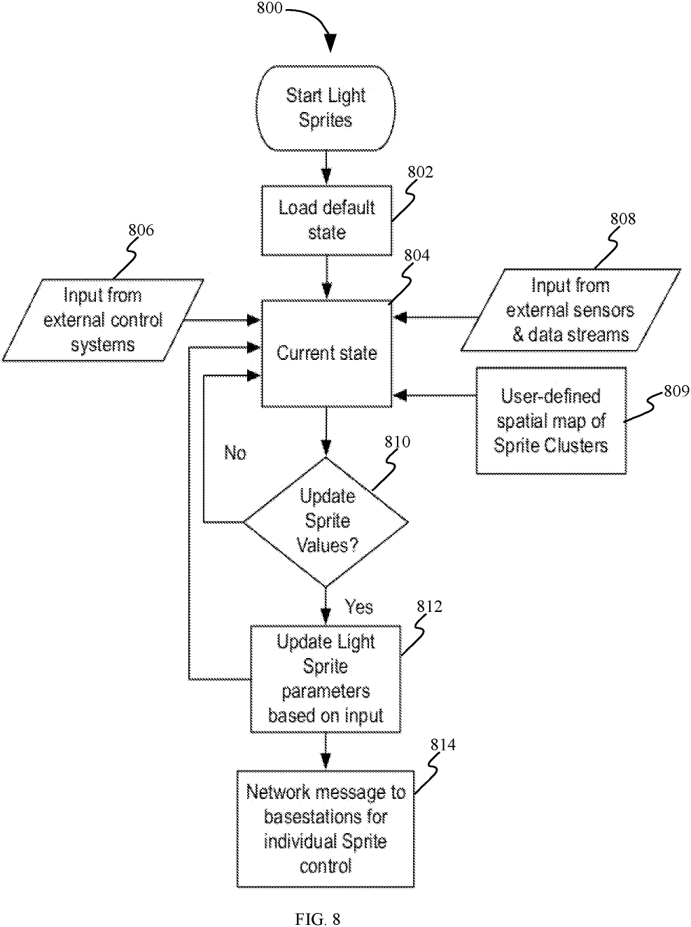

Referring now to FIG. 8, there is shown a flowchart diagram of some instructions operable on the system 100. The method comprises the steps of first loading a default state 802. Then, checking the current state 804. Next, accepting input from external control systems 806. Then, accepting input from external sensors and data streams 808. Next, determining if one or more than one light sprite value should be updated 810. Then, updating one or more than one light sprite parameters 812 and updating the current state 804 to reflect the updated parameters. Finally, transmitting a network message 814 to one or more than one base station to control individual light sprites.

Direct messages from external sources input step 806 are used to control defined light sprite 114 parameters, or trigger pre-defined presets. Different protocols can be used to communicate with the one or more than one controller unit 104, including various network protocols, such as, for example, TCP, UDP, Art-Net, sACN, OpenSoundControl (OSC), as well as a variety of serial protocols (e.g., DMX, MIDI).

One of the key features of the system 100 is its integration with environmental sensors, tracking systems, identification systems, activated props and sets, and other sensing technologies to create responsive spaces and engaging guest experiences.

The role of the incoming messages 806 and 808 is to alter specific light sprite 114 parameters in real-time in direct response to environmental or system changes external to the system 100. For example, movement data from a camera system that is tracking guests in a field could be used to control the presence of light sprites 114 within that area. Potential mappings might associate quick movements to a pre-programed scattering effect from the one or more than one light sprite 114, and observed stillness to the one or more than one light sprite 114 pre-programed “swarming” of the guests in that defined area. In this scenario, incoming messages would alter the number of light sprites active in a cluster, ranging from 0 to all, respectively.

The system 100 also incorporates flocking algorithms and associating the algorithms to be interactive with guest actions derived from incoming sensor data, with corresponding light sprite parameters. In this scenario, incoming messages declare “hot spots” center location for flocking, attraction or repulsion, the degree of attraction or repulsion, and the radius of light sprites affected by the flocking. Prior to this, a spatial map has been created providing the relative location of each light sprite cluster near the guests’ location, utilizing the same coordinates and reference points used in defining the “hot spot” location.

Dynamic messages usually come from external sources 806 and 808 via a predefined network packet for interactive inputs into the system 100. The pre-defined messages contain a header byte, command byte (e.g., setting a maximum time the sprite is in a HIGH state), destination bytes for the messages (e.g., Base #, Chain #, Link #, Cluster #, Sprite #, or user defined group #), payload bytes (e.g., RGB or HSV values), and checksum byte.

The incoming messages alter specific light sprite 114 parameters in real-time in direct response to environmental or system changes external to the system 100. For example, movement data from a camera system tracking guests in a field could be used to control the presence of illuminated light sprites within that area. Potential mappings might associate quick movements to light sprites scattering, and stillness to light sprites 114 “swarming” the guests in that defined area. In this scenario, incoming messages would alter the number of light sprites 114 active in a cluster, ranging from 0 to all, respectively.

Updated parameter values are distributed to the one or more than one base station 106 via UDP messages.

What has been described is a new and improved system for a dynamically controlled scalable lighting system comprising generative animations and dynamic behaviors for controlling a large number of individual light sprites with minimal requirements that can integrate into any environment using sensors and external communication protocols for interactive engagements, overcoming the limitations and disadvantages inherent in the related art.

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

What is claimed is:

1. A dynamically controlled scalable lighting system comprising:
a) one or more than one controller unit, wherein the one or more than one controller unit receives network messages using known protocols from external show or lighting control systems;
b) one or more than one external input and one or more than one data stream operably connected to the one or more than one controller unit;
c) one or more than one base station operably connected to the one or more than one controller unit using long-distance communication protocol network messages and, wherein the one or more than one base station provides power to all light sprites attached to each individual base station;
d) one or more than one link unit operably connected to the one or more than one base station;
e) one or more than one light sprite operably connected to the one or more than one link unit, wherein the one or more than one light sprite is encapsulated in a custom molded enclosure that is sealed from the elements, and are individually controlled algorithmically through adjustable control commands, or controllable and dynamically respond to the one or more than one external inputs in real time; and
f) at least one power source electrically connected to the one or more than one controller unit and the one or more than one base station.

2. The system of claim 1, wherein the one or more than one controller unit converts incoming standard show/lighting control messages into network messages that are sent to each connected base station.

3. The system of claim 1, wherein the one or more than one controller unit provides customizable system setup, real-time control, and advanced behavior customization of all light sprites on the same network.

4. The system of claim 1, wherein the one or more than one controller unit comprises one or more than one processor with instructions operable on the one or more than one processor for:
a) generating animations;
b) generating dynamic behaviors;
c) controlling a large number of individual light sprites with minimal requirements that can integrate into any environment using sensors and external communication protocols for interactive engagements;
d) creating dynamic virtual fixtures based on customizable light sprite groupings;
e) triggering preset animation behaviors;
f) creating customized behaviors and modifiers for easy triggering;
g) operating real time triggered queued scenes;
h) mapping external inputs to light sprite control commands;
i) creating fixtures based on light sprite groupings, allowing easy control from a central lighting control system;
j) triggering preset animation behaviors; and
k) creating customized behaviors and modifiers for easy triggering.

5. The system of claim 1, wherein the one or more than one controller unit functions independently, in communication with external control systems, or both independently and in communication with external control systems using a variety of communication protocols.

6. The system of claim 1, wherein the one or more than one controller unit comprises instructions operable for controlling the one or more than one base station, the one or more than one chain, the one or more than one link, and one or more than one cluster, wherein a cluster comprises a plurality of light sprites that operate as a logical group.

7. The system of claim 1, wherein the one or more than one controller unit connects the one or more than one light sprite to a larger show and lighting control system, converting incoming standard lighting control messages into a streamlined proprietary format.

8. The system of claim 1, wherein the one or more than one control unit comprises instructions for controlling one or more than one light sprite with minimal requirements for interactive engagements that can integrate into any environment using preset animations and real-time dynamic behavior simulations comprising flocking behavior, natural characteristics, movement by living organisms, particle-like behavior including: fireworks, pixie dust, camera flashes, star fields, comets, moving lines, marquee lights, fire embers, and sparks.

9. The system of claim 1, wherein the one or more than one external input comprise existing show/lighting controllers, wherein the one or more than one control unit comprises executable instructions to receive the external inputs and display sophisticated behaviors for a user-definable number of light sprites to be triggered and modified, without overwhelming any connected system to create responsive spaces and engaging guest experiences by activating one or more than one light sprite in response to the one or more than one external input.

10. The system of claim 1, wherein the one or more than one external inputs comprise: environmental sensors, tracking systems, identification systems, activated props, activated sets, motion sensors, cameras, depth sensors, LIDAR, RADAR, touch sensors, sound sensors, IR sensors, acoustic sensors, weather sensors, identification sensors, RFID, QR code, BLE beacons, marker and markerless camera tracking, and sensing technologies.

11. The system of claim 1, wherein the base station comprises at least one processor and receives network messages from the one or more than one controller unit and executes instructions executable on the at least one processor to translate the received network messages to control commands and configuration information and apply the control command and configuration information to pre-existing programmatic behaviors as individual light sprite control data, that is passed to the correct chain, link, and sprite, wherein the generated animations and dynamic behaviors are pre-programmed, a real-time response to one or more than one external input, or both pre-programmed and a real-time response to one or more than one external input.

12. The system of claim 1, wherein the one or more than one base station receives network messages from the one or more than one controller unit and translates the received network messages to control data, then sends the control messages along a chain to the one or more than one link unit, and finally to a light sprite, wherein the control data comprise: color and brightness driver commands for the one or more than one light sprite.

13. The system of claim 1, wherein the one or more than one link unit comprises:
a) one or more than one power and data input port;
b) one or more than one transceiver;
c) power distribution for the light sprites attachable to the one or more than on link unit;
d) one or more than one light sprite driver; and
e) a wired, wireless or both wire and wireless connector for transmitting light sprite commands and optionally power.

14. The system of claim 11, wherein the one or more than one link unit receives and decodes commands from the one or more than one base station and activates each individual light sprite to behave according to the commands.

15. The system of claim 11, wherein the one or more than one light sprite is completely independent from the light sprite driver.

16. The system of claim 1, wherein the one or more than one light sprite comprises an electrical and communication home run connection back to its corresponding link unit.

17. The system of claim 1, wherein the one or more than one light sprite is hot swappable without affecting the functionality of neighboring light sprites.

18. A method for a dynamically controlled scalable lighting system comprising the steps of:
a) loading a default state;
b) checking the current state;
c) accepting input from external control systems;
d) accepting input from external sensors and data streams;
e) determining if one or more than one light sprite value should be updated;
f) updating one or more than one light sprite parameters; and
g) transmitting a network message to one or more than one base station to control one or more than one individual light sprite.
